(19) United States
(12) Patent Application Publication
(10) Pub. No.: US 2026/0194879 A1
(43) Pub. Date: Jul. 9, 2026

(54) MULTI-SENSORY PLANT FLOOR SYSTEM FOR PROGRAMMABLE LOGIC CONTROLLER DATA CONVERSION AND DISPLAY

(71) Applicant: MicroCODE, Inc. dba MicroCODE Incorporated, Troy, MI (US)

(72) Inventor: Timothy John McGuire, Macomb, MI (US)

(21) Appl. No.: 19/067,891

(22) Filed: Mar. 1, 2025

Related U.S. Application Data
(60) Provisional application No. 63/560,624, filed on Mar. 1, 2024.
(60) Provisional application No. 63/679,581, filed on Aug. 5, 2024.

(51) Int. Cl. G05B 19/05

(52) U.S. Cl. CPC G05B 19/054

(57) ABSTRACT

A system and method for communicating programmable logic controller (PLC) data to an operator. The method includes receiving sequential data having a predefined structure from the programmable logic controller (PLC), converting the received data into one or more media formats using a data conversion module, determining at least one of the one or more media output devices to receive at least part of the converted data using a configuration framework, transmitting the at least part of the converted data to each corresponding one of the determined one or more output devices and outputting the transmitted data from the one or more media output devices to the operator.

### CROSS-REFERENCE TO RELATED APPLICATIONS

This application claims the benefit of priority of U.S. Provisional Application No. 63/679,581 filed on Aug. 5, 2024, and U.S. Provisional Application No. 63/560,624 filed on Mar. 1, 2024, the disclosure of which are both incorporated herein by reference in its entirety.

### FIELD OF THE INVENTION

Embodiments described herein generally relate to industrial automation and control systems, specifically to a plant floor system that converts sequential data from a Programmable Logic Controller (PLC) into various media formats that are presented directly to plant floor operators.

### BACKGROUND OF THE INVENTION

Modern industrial facilities rely on automation and control systems to monitor and manage various processes. Programmable Logic Controllers (PLCs) are widely used in these systems to receive and process input data from sensors and other devices, then actuate outputs based on the processed data. However, existing methods for visualizing and understanding the data from PLCs are limited and often require specialized knowledge to interpret. Hence, there is a need for an intuitive application that can convert PLC data into a more accessible and user-friendly format for operators involved in the assembly process.

### BRIEF DESCRIPTION OF THE DRAWINGS

The various advantages of the embodiments of the present disclosure will become apparent to one skilled in the art by reading the following specification and appended claims, and by referencing the following drawing(s), in which:

FIG. 1 depicts an illustrative architecture in which techniques and structures for providing the systems and methods disclosed herein may be implemented.

FIG. 2 shows an exemplary view of a workstation control engine according to an embodiment of the present disclosure.

FIG. 3 shows an exemplary configuration tool according to an embodiment of the present disclosure.

FIG. 4 shows an exemplary configuration table for a display media output device according to an embodiment of the present disclosure.

FIG. 5 shows an exemplary configuration table for a haptic media output device according to an embodiment of the present disclosure.

FIG. 6 shows an exemplary high level flow diagram of a method for communicating PLC data to an operator according to an embodiment of the present disclosure.

FIG. 7 shows an exemplary high level flow diagram of a configuration process according to an embodiment of the present disclosure.

### SUMMARY OF THE INVENTION

Exemplary embodiments disclosed herein describe a computer implemented method of communicating programmable logic controller (PLC) to an operator. The method includes receiving sequential data having a predefined structure from the programmable logic controller (PLC); converting the received data into one or more media formats using a data conversion module, where each media format corresponds to a respective one of one or more media output devices; determining at least one of the one or more media output devices to receive at least part of the converted data using a configuration framework; transmitting the at least part of the converted data to each corresponding one of the determined one or more output devices; and outputting the transmitted data from the one or more media output devices to the operator.

In some exemplary embodiments the method includes generating at least one configuration table for at least one of the one or more media output devices based on user customization data.

In some exemplary embodiments the configuration framework includes a plurality of tables including the at least one table generated for the at least one of the one or more media output devices.

In some exemplary embodiments the method includes decoding the received data consistent with the predefined format using the data conversion module.

In some exemplary embodiments the method includes evaluating the decoded data against predefined conditions to determine if a trigger event has occurred for any of the one or more media output devices.

In some exemplary embodiments the received data is converted into the one or more formats if the trigger event has occurred for any of the one or more media output devices.

In some exemplary embodiments the method includes receiving media acquisition files relating to the one or more media output devices from a remote device via a network during a configuration process.

In some exemplary embodiments the plurality of tables is generated during a configuration process that allows a user to enter user customization data and interactively test the user customization data on one or more media output devices.

In some exemplary embodiments the method includes synchronizing the transmission of the at least part of the converted data to a corresponding one of the one or more output devices with a timing of movement of objects from one workstation to another in a moving assembly line.

Other exemplary embodiments disclosed here describe a system for communicating PLC data to an operator. The system includes one or more media output devices and a workstation control engine. The workstation control engine includes a configuration framework including a plurality of tables; at least one non-transitory memory storing the configuration framework and an application (APP). The APP contains instructions that when executed by the at least one processor, cause the processor to receive sequential data from the programmable logic controller (PLC) having a predefined format, convert the received data into one or more formats using a data conversion module, wherein each format corresponds to a respective one of the one or more media output devices; determine at least one of the one or more media output devices to receive at least part of the converted data using the configuration framework; transmit the at least part of the converted data to each corresponding one of the determined one or more media output devices; and output the transmitted data from the one or more media output devices to the operator.

In some exemplary embodiments, the at least one memory further comprises instructions that when executed by the at least one processor, cause the processor to generate at least one configuration table for at least one of the one or more media output devices based on user customization data.

In some exemplary embodiments, the at least one memory further comprises instructions that when executed by the at least one processor, cause the processor to decode the received data consistent with the predefined format using the data conversion module.

In some exemplary embodiments, the data conversion module includes instructions that when executed by the at least one processor, cause the processor to evaluate the decoded data against predefined conditions to determine if a trigger event has occurred for the one or more media output devices.

In some exemplary embodiments, the received data is converted into the one or more formats if the trigger event has occurred for any of the one or more media output devices.

In some exemplary embodiments, the at least one memory further comprises instructions that when executed by the at least one processor, cause the processor to receive media acquisition files relating to the one or more media output devices from a remote device via a network during a configuration process.

In some exemplary embodiments, the one or more configuration tables is generated during a configuration process that allows a user to enter user customization data and interactively test the user customization data on one or more output devices.

In some exemplary embodiments, the at least one memory further comprises instructions that when executed by the at least one processor, cause the processor to synchronize the transmission of the at least part of the converted data to a corresponding each of the one or more output devices with a timing of movement of objects from one workstation to another in a moving assembly line.

### DETAILED DESCRIPTION

The disclosure will be described more fully hereinafter with reference to the accompanying drawings, in which exemplary embodiments of the disclosure are shown. This disclosure may, however, be embodied in many different forms and should not be construed as limited to the exemplary embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described exemplary embodiments but should be defined only in accordance with the following claims and their equivalents. The terms programmable logic controller and PLC have been used interchangeably throughout the disclosure.

The present disclosure describes an application (APP) used in a plant floor system. In an exemplary plant floor workflow, a car order may be entered into an enterprise resource planning (ERP) system, which includes details like model, color, features, and any special customization. The ERP system processes the order and sends it to the MES. The MES schedules the production order and breaks it down into specific tasks and instructions for different stages of the assembly line. The MES dispatches these instructions to the relevant PLCs on the factory floor using industrial communication protocols. The PLCs execute the instructions, control machinery and coordinate tasks to assemble the car according to the order specifications. This coordination of tasks to assemble the car includes sending data (e.g., sequential data) to one or more operator workstations along the assembly line for a specific task.

The application (APP) receives the sequential data from the PLC and converts it into various media formats through an intuitive configuration framework without requiring any PLC code or custom application code to be written by the end user to understand the PLC sequential data. The application can transform PLC data into various effects including colorized words or phrases, sounds from .WAV files, spoken voices from TEXT, images from .PNG, .JPG, or similar files, videos from .MP4, or similar files, haptic feedback, or direct operator sensations. These effects provide a simple way to communicate the PLC data transformed into text, sound, voice, images, videos, haptic, or sensations for the operator, emphasizing infrequent assembly situations, such as, for example, special or custom orders, which require extra effort or preparation on the operator's part.

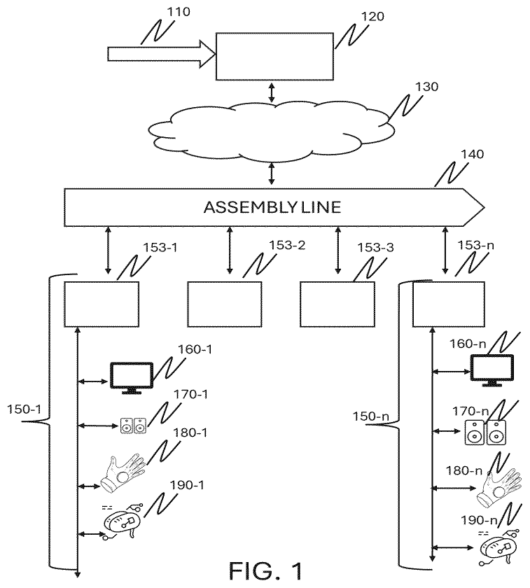

Turning to FIG. 1, an exemplary embodiment of a system for communicating PLC data to an operator (“the system”) 100 in a plant factory is shown and includes an order interface 110, a programmable logic controller (PLC) 120, a network 130, an assembly line 140 and a plurality of workstations 150 a-150n, a plurality of display devices 160-1-160-n, a plurality of audio devices 170-1-170-n, a plurality of haptic devices 180-1-180-n, and a plurality of neural link devices 190-1-190-n.

Order interface 110 is embedded with logic and code for interfacing with programmable logic controller 120, including, for example, a network that facilitates real-time communication and data exchange. The network may include any one of or a combination of multiple different types of networks, such as, cable networks, the Internet, wireless networks, and other private and/or public networks.

The order interface 110 may provide orders received from a Manufacturing Execution System (MES) to the PLC 120. These orders may include detailed instructions on what needs to be produced, in what quantity, and in what sequence. The order interface sends specific commands and production schedules to the PLC to control the assembly line operation, such as start and stop commands, production parameters, and specific task instructions. In some implementations of the teachings herein, the order interface includes the MES.

The programmable logic controller (“PLC”) 120 may be implemented as an industrial digital computer designed for control and automation of manufacturing processes, such as assembly lines, robotic devices, or any activity requiring high reliability and ease of programming. The PLC receives orders from order interface 110 and controls, manages and coordinates the execution of the orders on the assembly line 140.

Network 130 may include any one of or a combination of multiple different types of networks, such as, cable networks, the Internet, wireless networks, and other private and/or public networks. In some instances, the network 130 may include cellular, Wi-Fi, or Wi-Fi direct. The network 130 may comprise any combination of local area and/or wide area networks, using both wired and wireless communication systems.

Assembly line 140 may be configured as a moving assembly line including a conveyor system, rollers, guides and rails, sensors and actuators, control systems for the operation of machinery and equipment on the assembly line, robotics arms, automated machinery, assembly robots, automated guided vehicles and workstations 150-1-150-n.

Workstations 150-1-150-n are operator stations where human workers may perform tasks in the factory. Each workstation may include a computer 153-1-153-n including a workstation control engine (WCE) 155 and APP 157, a tool station (not shown), a human-machine interface (HMI) including one or more control panels which allow an operator to interact with the assembly line, commands and monitor status, one or more touchscreens and/or displays 160-1-160-n, one or more auditory devices 170-1-170-n, one or more haptic devices 180-1-180-n, and one or more neural link devices 190-1-190-n, a safety system, and inspection station.

In some implementations of the teachings herein, each workstation is located at a position along the assembly line where a particular process or task is to be performed by an operator. For example, workstation 150-1 may be configured for installation of dash boards. So, the location of this workstation will be positioned on the plant floor in the assembly line where the conveyor belt will move the car for an operator to install a dashboard.

Computers 153-1-153-n may be implemented using an industrial personal computer including workstation control engine 155 and APP 157.

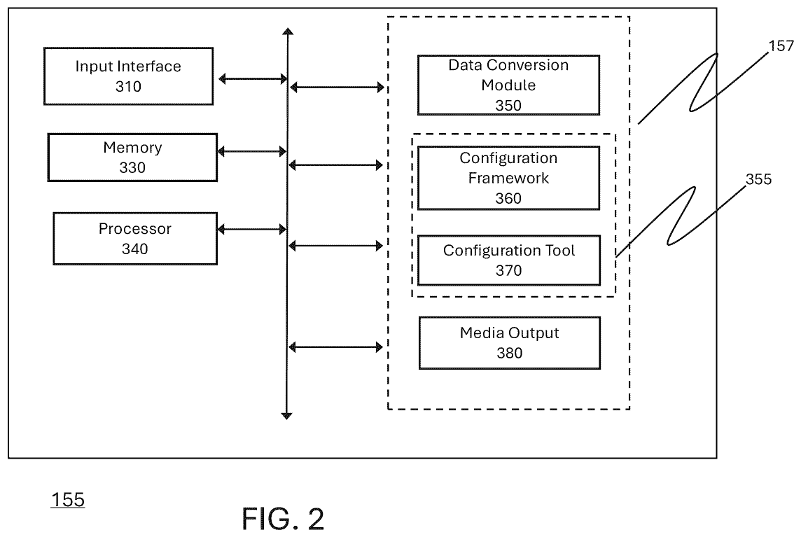

Turning to FIG. 2, workstation control engine (WCE) 155 includes an input interface 310, a memory 330, at least one processor 340, and APP 157. APP 157 includes data conversion module (DCM) 350, configuration framework 355 which includes one or more configuration tables 360 and configuration tool 370, and a media output module 380.

The input interface 310 is embedded with logic and code for interfacing with programmable logic controller 120 and/or assembly line 140 and may include a network that facilitates real-time communication and data exchange with workstation 150, PLC 120 and/or assembly line 140.

The data conversion module (DCM) 350 in APP 157 contains instructions stored in memory 330 that when executed by at least one processor 340, cause the at least one processor to receive sequential data provided by PLC 120 and convert the received data into one or more media formats.

The data conversion module (DCM) 350 receives sequential data from the PLC 120 from input interface 310. The sequential data has a predefined structure that allows the DCM to parse and decode segments of the data. So, for example, the DCM may receive the following sequential data in JSON format:

```
{
  ″assembly_sequence″: [
    { ″step″: 1,
      ″operation″: ″Install dashboard″,
      ″machine_id″: ″M4″,
      ″duration″: 50,
      ″parameters″: {
        ″alignment″: ″precise
      }
    },
        {
      ″step″: 2,
      ″operation″: ″Special Order: Install custom leather seats″,
      ″operator_id″: ″O1″,
      ″duration″: 90,
      ″parameters″: {
        ″color″: ″black″,
        ″stitching″: ″contrast″
      }
    },
    {
      ″step″: 3,
        “operation″: ″Install wheels and tires″,
      ″machine_id″: ″M5″,
      ″duration″: 40,
      ″parameters″: {
        ″torque″: ″110Nm″
      }
    },
    {
      ″step″: 4,
      ″operation″: ″Special Order: Install premium sound system″,
      ″operator_id″: ″O2″,
      ″duration″: 60,
      ″parameters″: {
        ″brand″: ″HighEndAudio″,
        ″speakers″: 10
      }
    },
    {
      ″step″: 5,
      ″operation″: ″Special Order: Apply custom paint job″,
      ″operator_id″: ″O3″,
      ″duration″: 120,
      ″parameters″: {
        ″color″: ″midnight blue″,
        ″finish″: ″metallic″
      }
    },
  ]
}
```

The DCM 350 may parse the sequential data and evaluate sections of the data based on its predefined structure. So, for example, the DCM may recognize each section by identifying a curly brace ‘{’ at the beginning of the section and a curly brace ‘}’ at the end of the section followed by ‘},’. Each section is enclosed in a pair of curly braces ‘{ }’ and the sections are separated by ‘}’ following the pair of curly braces.

The DCM 350 may decode the sequential data section by section consistent with its predefined format. Next, the DCM may evaluate each section against one or more predefined conditions to determine if a trigger event has occurred. The one or more predefined conditions may represent special or custom orders. In this instance, the DCM may evaluate each section to determine whether a special or custom order exists. The one or more predefined conditions may be customized using configuration tool 370 and stored in an application configuration table.

Referring to the above exemplary sequential data, the DCM 350 will determine that steps 2, 4 and 5 include special orders, and thus three trigger events have occurred. Once it is determined that a trigger event has occurred, the DCM may interface with configuration framework 355 to determine how to convert the data (e.g., the special or custom order instruction) and where to transmit the converted data for communication with an operator.

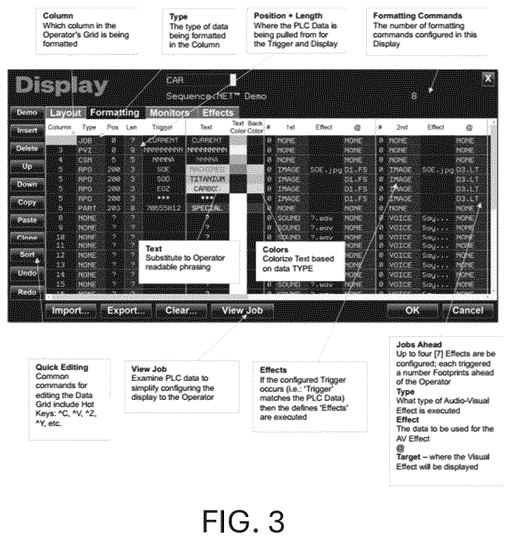

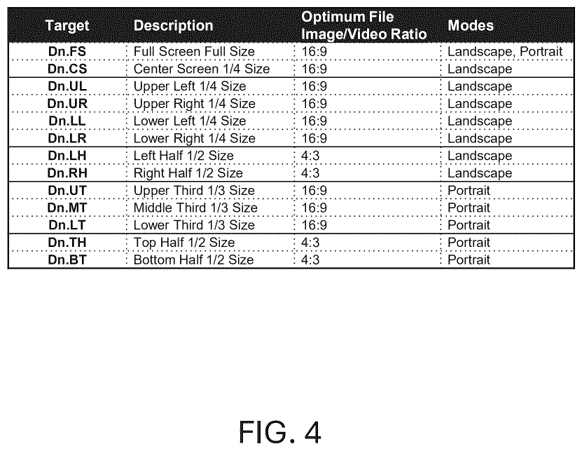

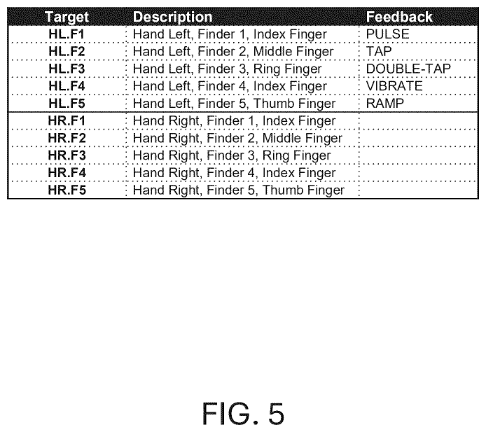

The configuration framework 355 includes one or more configuration tables 360, e.g., the tables shown in FIGS. 4-5, and a configuration tool 370. The configuration tool may be an interactive graphical user interface that allows a user (e.g., an engineer) to set up customized configurations for communicating information to an operator. FIG. 3 shows an exemplary configuration tool that allows the user to customize data communication configurations and from which an application configuration table is generated. The application configuration table functions as conditional logic to allow the DCM 350 to perform data conversions. The selections made using the configuration tool (i.e., user customization data) are evaluated by the DCM as if-then logic. Hence, if a particular trigger occurs, then the DCM will perform a data conversion consistent with the user configuration selections.

So, for example, a user may choose during a configuration process to display a video of a black car on a video display to communicate to the operator that the car approaching its station has a custom order to paint the car black. The DCM will convert the sequential data “Special Order: Apply custom paint job” to a video effect and communicate the video to the operator via the at least one display media output device 160. Since, there may be more than one display device and/or multiple display areas on a display device, the DCM 350 may interface with a display configuration table, such, as, for example, the table shown in FIG. 4, to determine where and how the visual effect should be shown to an operator. The targeted device is denoted by Dn (i.e., display number) and the targeted area of display is denoted by ta (i.e., targeted area of display).

Further, the configuration framework may include a configuration table for one or more media output devices. The table may be configured as JSON data structures. The media output devices may include display 160, audio device 170, haptic device 180, and neural link device 190. Each configuration table may be configured during the configuration process using the configuration tool 370. In some implementations of the teachings herein, the configuration tool may be used to modify any one or more of the configuration tables after the configuration process.

FIG. 5 shows an exemplary configuration table for one or more haptic media output devices. The table specifies where and how a vibration output will be given to an operator through output devices worn (e.g., a haptic media output device) during product assembly. “Xs” designates body part, side. “Pn” designates targeted sub-part, which are identified in the table as follows:
NOGGIN=NL, NR . UL, UR, LL, LR.
TORSO=TF, TR . UL, UR, LL, LR
ARM=AL, AR . UT, MT, LT
HAND=HL, HR. F1 thru F5
LEG=LL, LR . UT, MT, LT
FEET=FL, FR . T1 thru T5

Although not shown, it should be noted that one or more configuration tables may be generated for any of the media output devices.

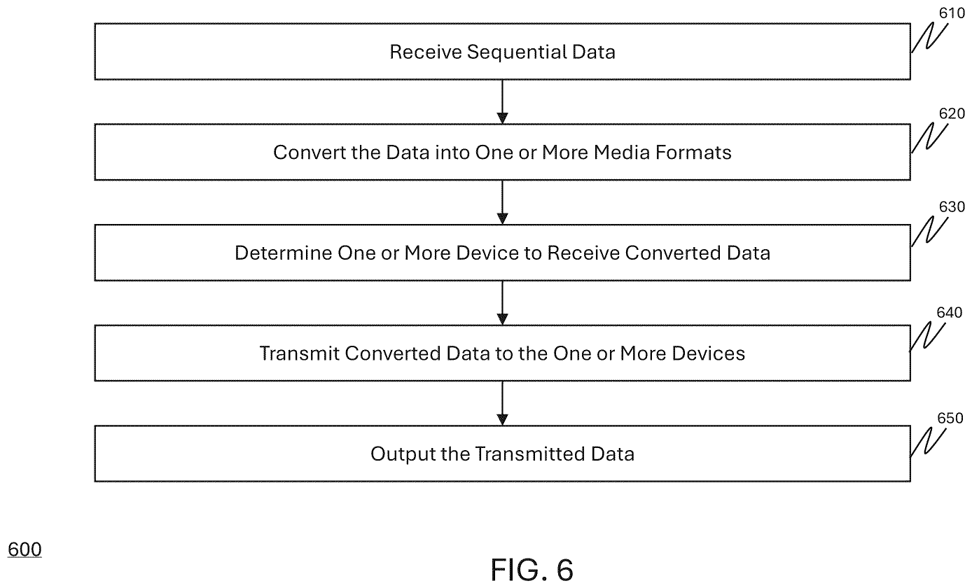

FIG. 6 shows an exemplary high level flow diagram 600 of a method for communicating PLC data to an operator according to an embodiment of the present disclosure. The process starts at step 610 where the workstation control engine (WCE) 155 receives sequential data having a predefined structure from the programmable logic controller (PLC). At step 620, the WCE converts the received data into one or more media formats using DCM 350. At step 630, the WCE determines at least one of the one or more media output devices to receive at least part of the converted data using configuration framework 355. At step 640, the WCE transmits at least part of the converted data to each corresponding one of the determined one or more output devices in synchronized timing with receipt of the part at the workstation from the assembly line. At step 750, the WCE outputs the transmitted data from the one or more media output devices to the operator.

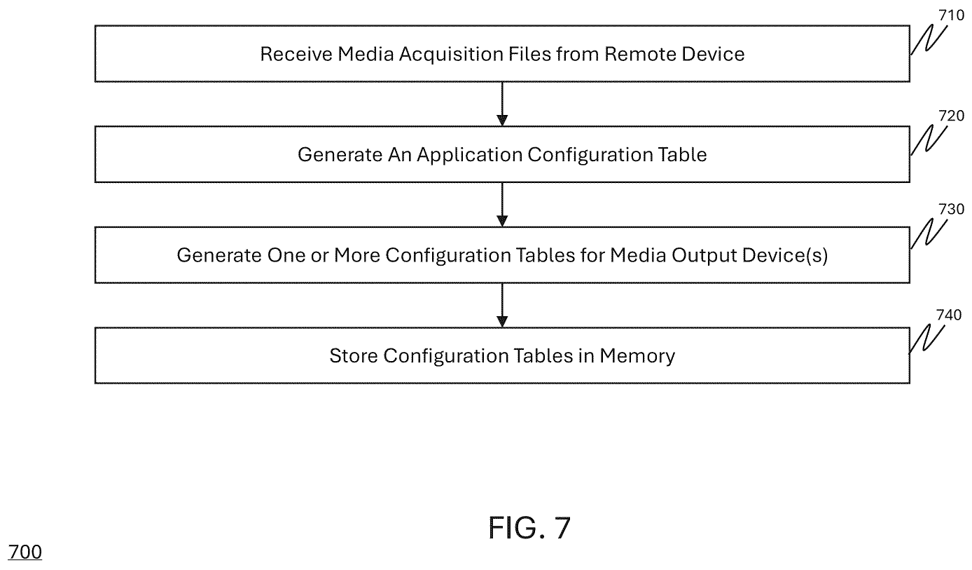

FIG. 7 shows an exemplary high level flow diagram 700 of a configuration process according to an embodiment of the present disclosure. The process starts at step 710 where media acquisition files relating to one or more media output devices are received at the workstation control engine (WCE) 155 from a remote device (e.g., PLC or MES) via a network. The media acquisition files are stored in memory 330 to allow the WCE to continue its operation in the event of a network outage. At step 720, a user is presented with configuration tool 370 to generate at least one application configuration table. The configuration tool allows the user to interactively test and preview the selected settings. So, the user may make changes until the desired settings are selected. At step 730, the user may generate one or more configuration tables for one or more of the media output devices (i.e., 160, 170, 180 and 190). Again, the user may test and preview the selected settings until the desired settings are achieved. At step 740, the tables are stored in memory 330 and the configuration framework is complete.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Any memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random access memory (RAM) (electronic), a read-only memory (ROM) (electronic), an erasable programmable read-only memory (EPROM, EEPROM, or Flash memory) (electronic), and a portable compact disc read-only memory (CD ROM) (optical).

The terms “module’ and “component as used herein generally represent software, firmware, hardware, or combinations thereof. In the case of a software implementation, the module or component represents program code that performs specified tasks when executed on a processor. The program code may be stored in one or more computer readable memory devices.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). The term computer-readable storage media does not include signals and carrier waves. In addition, the term computer-readable storage media does not include communication connections.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

What is claimed is:

1. A computer implemented method of communicating programmable logic controller (PLC) data to an operator, the method comprising the steps of:
receiving sequential data having a predefined structure from the programmable logic controller (PLC);
converting the received data into one or more media formats using a data conversion module, wherein each media format corresponds to a respective one of one or more media output devices;
determining at least one of the one or more media output devices to receive at least part of the converted data using a configuration framework;
transmitting the at least part of the converted data to each corresponding one of the determined one or more output devices; and
outputting the transmitted data from the one or more media output devices to the operator.

2. The method of claim 1 further comprising generating at least one device configuration table for at least one of the one or more media output devices based on user customization data.

3. The method of claim 2 wherein the configuration framework includes a plurality of tables including the at least one device configuration table generated for the at least one of the one or more media output devices.

4. The method of claim 1 further comprising decoding the received data consistent with the predefined format using the data conversion module.

5. The method of claim 4 further comprising evaluating the decoded data against predefined conditions to determine if a trigger event has occurred for any of the one or more media output devices.

6. The method of claim 5 wherein the received data is converted into the one or more formats if the trigger event has occurred for any of the one or more media output devices.

7. The method of claim 1 further comprising receiving media acquisition files relating to the one or more media output devices from a remote device via a network during a configuration process.

8. The method of claim 3 wherein the plurality of tables is generated during a configuration process that allows a user to enter user customization data and interactively test the user customization data on one or more media output devices.

9. The method of claim 1 wherein at least one of the plurality of tables generated during the configuration process is an application configuration table.

10. The method of claim 1 wherein the configuration framework includes a configuration tool.

11. The method of claim 1 further comprising synchronizing the transmission of the at least part of the converted data to a corresponding one of the one or more output devices with a timing of movement of objects from one workstation to another in a moving assembly line.

12. A system for communicating PLC data to an operator in a multi-sensory plant comprising:
one or more media output devices;
a workstation control engine comprising:
at least one processor;
a configuration framework including one or more configuration tables;
at least one non-transitory memory storing the configuration framework and an application that contains instructions that when executed by the at least one processor, cause the processor to:
receive sequential data from the programmable logic controller (PLC) having a predefined format,
convert the received data into one or more formats using a data conversion module, wherein each format corresponds to a respective one of the one or more media output devices;
determine at least one of the one or more media output devices to receive at least part of the converted data using the configuration framework;
transmit the at least part of the converted data to each corresponding one of the determined one or more media output devices; and
output the transmitted data from the one or more media output devices to the operator.

13. The system of claim 12 wherein the at least one memory further comprises instructions that when executed by the at least one processor, cause the processor to:
generate at least one configuration table for at least one of the one or more media output devices based on user customization data.

14. The system of claim 12 wherein the at least one memory further comprises instructions that when executed by the at least one processor, cause the processor to:
decode the received data consistent with the predefined format using the data conversion module.

15. The system of claim 14 wherein the data conversion module includes instructions that when executed by the at least one processor, cause the processor to:
evaluate the decoded data against predefined conditions to determine if a trigger event has occurred for the one or more media output devices.

16. The system of claim 15 wherein the received data is converted into the one or more formats if the trigger event has occurred for any of the one or more media output devices.

17. The system of claim 11 wherein the at least one memory further comprises instructions that when executed by the at least one processor, cause the processor to:
receive media acquisition files relating to the one or more media output devices from a remote device via a network during a configuration process.

18. The system of claim 11 wherein the one or more configuration tables is generated during a configuration process that allows a user to enter user customization data and interactively test the user customization data on one or more output devices.

19. The system of claim 11 wherein at least one of the one or more configuration tables includes an application configuration table.

20. The system of claim 11 wherein the at least one memory further comprises instructions that when executed by the at least one processor, cause the processor to:
synchronize the transmission of the at least part of the converted data to a corresponding each of the one or more output devices with a timing of movement of objects from one workstation to another in a moving assembly line.
